(19) United States
(12) Patent Application Publication
(10) Pub. No.: US 2007/0223664 A1
(43) Pub. Date: Sep. 27, 2007

(54) Server apparatus

(75) Inventors: Fumikazu Matsukawa, Ome-shi (JP); Shigeru Fukazawa, Hachioji-shi (JP); Yasumasa Sasaki, Tachikawa-shi (JP); Shinichi Kashimoto, Ome-shi (JP); Nobuyuki Takeda, Hachioji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/713,616

(22) Filed: Mar. 5, 2007

(30) Foreign Application Priority Data
Mar. 24, 2006 (JP) 2006-083916

(51) Int. Cl. H04M 15/06; H04M 1/56

(52) U.S. Cl. 379/142.01

(57) ABSTRACT

According to one embodiment, a server apparatus includes a first memory which memorizes group tables respectively showing correspondence relations between groups constituted by dividing the plurality of data terminals and data IDs of data terminals belonging to these groups, a second memory which memorizes band tables respectively showing correspondence relations between combinations of the plurality of groups and bands usable among plurality of data terminals to be communication-connected, and a controller which refers to the group tables and the band tables based on data IDs associated with the phone IDs included in the call information event, when the call information event is received, and executes communication connections among data terminals corresponding to the data IDs based on the reference result to assign bands to the data terminals.

### CROSS-REFERENCE TO RELATED APPLICATIONS

This application is based upon and claims the benefit of priority from Japanese Patent Application No. 2006-083916, filed Mar. 24, 2006, the entire contents of which are incorporated herein by reference.

### BACKGROUND

1. Field

One embodiment of the invention relates to an improvement of a server apparatus of a visual communication system which connects the server apparatus via a communication line to, for example, a telephone exchange and enables treating a video signal, computer data, etc., in addition to a voice signal.

2. Description of the Related Art

A local area network (LAN) has been used in an office and a business establishment. This LAN system accommodates, for instance, telephone sets as extension terminals into a telephone exchange, such as a private branch exchange (PBX) and a key telephone apparatus, and allows conversations by switch-connecting between the extension terminals and an external communication network, such as a public network, and among mutual extension terminals.

Recently, a system has been proposed, wherein video phone terminals and a server with data terminals such as personal computers connected thereto, are connected to the telephone exchange via a transmission line then a voice communication system using the telephone exchange and a data communication system using the server work together.

By the way, in the foregoing system in which the telephone exchange and the server are arranged in parallel with each other, a video communication system also has been strongly desired, wherein the communication system configures a video conference, etc., by making data communication connections among the data terminals work together with call states of the phone terminals. In a communication network among the server and a plurality of data terminals, a processing load or a traffic load sometimes increases depending on a use time zone or a use environment, etc., then an error in session establishment among data terminals sometimes occurs.

Up to now, a method, in which the server acquires quality information (usable codec/zone information) of the data terminals to accomplish the session establishment from each data terminal, calculates optimum bands to notify them to each data terminal, and then, establishes sessions in the optimum bands among the data terminals, has been proposed (for example, Jpn. Pat. Appln. KOKAI Publication No. 2005-129981).

However, in the method, the server executing processing from acquiring the quality information of the data terminals up to the session establishment among the data terminals, the processing load at the server becomes heavy. This fact becomes clearer as the scale of the communication system becomes larger.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting a visual communication system regarding a first embodiment of the present invention;

FIG. 2 is an exemplary block diagram depicting a functional configuration of a visual communication solution (VCS) server depicted in FIG. 1;

FIG. 3 is an exemplary view depicting an example of storage content in a connection information management table depicted in FIG. 2;

FIG. 4 is an exemplary view depicting an example of storage content in an extension terminal-data terminal (visual communication (VC)) association table depicted in FIG. 2;

FIG. 5 is an exemplary view depicting an example of storage content in a session information management table depicted in FIG. 2;

FIG. 6 is an exemplary view depicting an example of storage content in a group table depicted in FIG. 2;

FIG. 7 is an exemplary view depicting an example of storage content in a communication band table depicted in FIG. 2;

FIG. 8 is an exemplary sequence view depicting operations when data terminals are associated with extension terminals in the first embodiment;

FIG. 9 is an exemplary flowchart depicting the control processing procedure of the VCS server in deciding communication band values to be assigned to the data terminals;

FIG. 10 is an exemplary block diagram depicting a functional configuration of the VCS server as a second embodiment of the invention;

FIG. 11 is an exemplary view depicting an example of storage content in a schedule table depicted in FIG. 10;

FIG. 12 is an exemplary view depicting an example of storage content in a communication band table depicted in FIG. 10;

FIG. 13 is an exemplary block diagram depicting the functional configuration of a VCS server SVC as a third embodiment of the invention; and

FIG. 14 is an exemplary view depicting for explaining operations in shifting the same data terminal into a different environment in the third embodiment.

### DETAILED DESCRIPTION

Various embodiments according to the invention will be described hereinafter with reference to the accompanying drawings. In general, according to one embodiment of the invention, A server apparatus which receives a call information event including phone IDs specifying a plurality of phone terminals to be call-connected, and makes communication connections of a plurality of data terminals work together with the call connections, the data terminals being associated with the phone IDs of the plurality of phone terminals, respectively, and the data terminals being assigned data IDs, the server apparatus comprising: a first memory which memorizes group tables respectively showing correspondence relations between groups constituted by dividing the plurality of data terminals and data IDs of data terminals belonging to these groups; a second memory which memorizes band tables respectively showing correspondence relations between combinations of the plurality of groups and bands usable among plurality of data terminals to be communication-connected; and a controller which refers to the group tables and the band tables based on data IDs associated with the phone IDs included in the call information event, when the call information event is received, and executes communication connections among data terminals corresponding to the data IDs based on the reference result to assign bands to the data terminals.

### First Embodiment

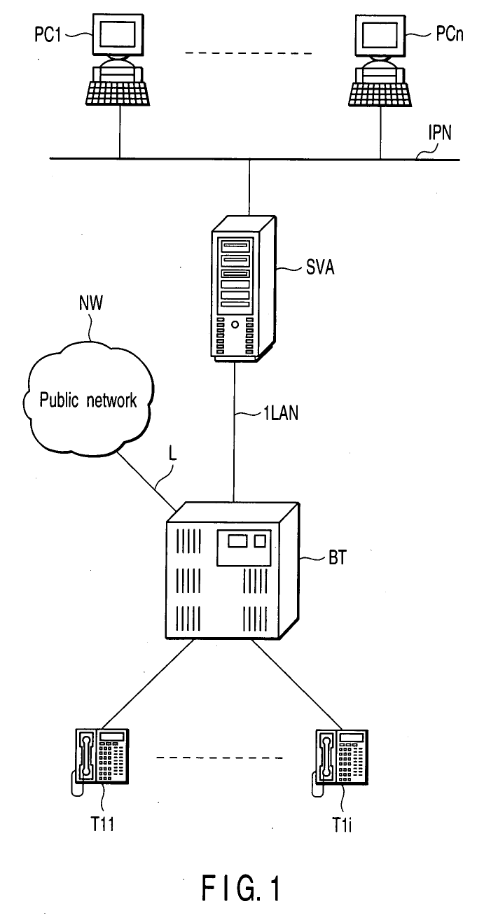

FIG. 1 is a schematic configuration view illustrating a visual communication system regarding a first embodiment of the invention.

The communication system, as shown in FIG. 1, includes a main apparatus BT and a video communication solution (VCS) server SVA, and connects between the main apparatus BT and the VCS server SVA through a local area network (LAN) 1.

The main apparatus BT accommodates extension terminals T11 to T1i via extensions. The main apparatus BT is connected to a public network NW via an office line L. The main apparatus BT executes exchange processing among mutual extension terminals T1 to T1i, or among the extension terminals T11 to T1i and the public network NW.

The VCS server SVA accommodates a plurality of data terminals PC1 to PCn through an Internet protocol (IP) network IPN. Each of these data terminals PC1 to PCn is composed of an all-purpose personal computer (PC), and operates in relation to each extension terminal T11 to T1i, respectively.

The VCS server SVA executes an additional function to the main apparatus BT, and processes media information of, for instance, a video, etc.

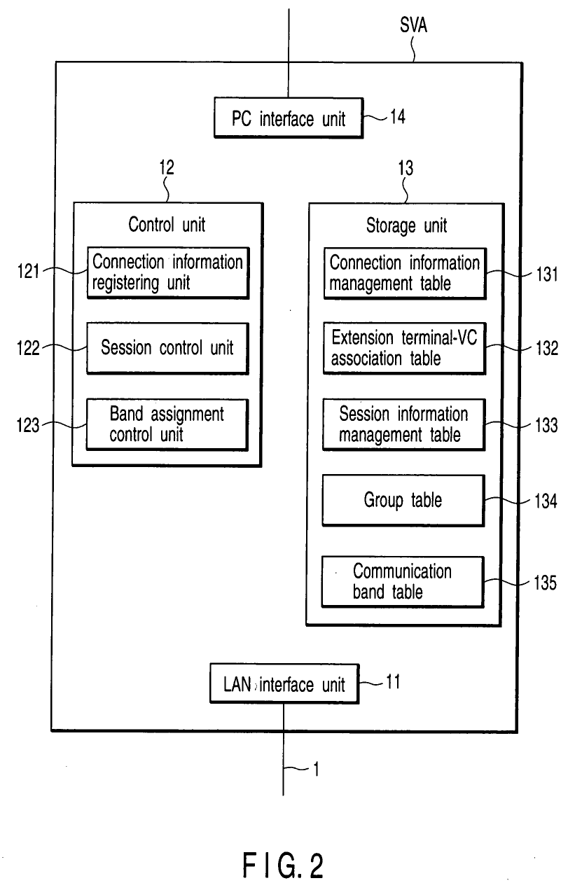

FIG. 2 is a block diagram illustrating a functional configuration of the VCS server SVA.

The VCS server SVA comprises a LAN interface unit 11, a control unit 12, a storage unit 13, and a PC interface unit 14. Among of them, the LAN interface unit 11 conducts interface processing to and from the LAN 1.

The PC interface unit 14 performs interface processing among the data terminals PC1 to PCn.

The storage unit 13 stores routing information, etc., necessary for connection control by the control unit 12. The storage unit 13 further includes a connection information management table 131, an extension terminal-data terminal (VC) association table 132, a session information management table 133, a group table 134, and a communication band table 135.

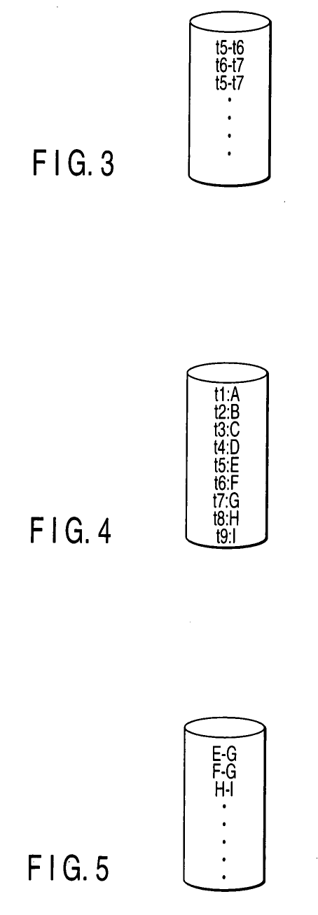

In the connection information management table 131, as shown in FIG. 3, data, indicating correspondence relations among each telephone number (phone ID) of the extension terminals T11 to T1i and state information showing connection states, is stored. The symbols t1 to t9 indicate each phone ID of the extension terminals T11 to T19, respectively. Here, to simplify a description, the extension terminals T11 to T1i are referred to as extension terminals T11 to T19.

In the extension terminal-VC association table 132, as shown in FIG. 4, data, showing correspondence relations among the extension terminals T11 to T1i and the data terminal (VC) PC1 to PCn, is stored. In FIG. 4, the symbols A to I respectively indicate each user ID of the data terminals PC1 to PC9.

In the session information management table 133, as shown in FIG. 5, information showing session states among data terminals PC1 to PC9 is stored.

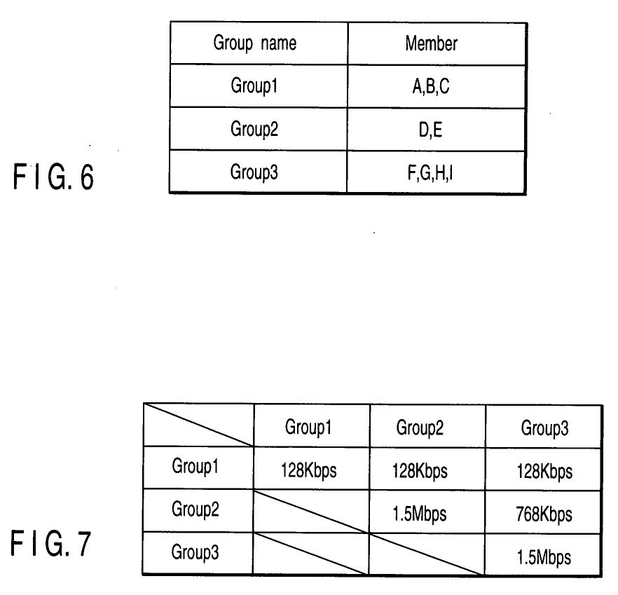

In the group table 134, as shown in FIG. 6, data, indicating correspondence relations among a plurality of groups Group 1, Group 2, Group 3 composed by dividing the data terminals PC1 to PC9 in response to a network environment and user IDs of the plurality of data terminals PC1 to PC9 belonging to these groups Group 1, Group 2 and Group 3, is stored.

In the communication band table 135, as shown in FIG. 7, data, indicating correspondence relations among combinations of the groups Group 1, Group 2, Group 3 and use band values, is stored.

On the other hand, the control unit 12 comprises a connection information registering unit 121, a session control unit 122, and a band assignment control unit 123 as new functions regarding the invention in addition to a control function related to state management of the data terminals PC1 to PCn and collaborative operations among the data terminals PC1 to PCn and the extension terminals T11 to T1i.

The connection information registering unit 121 analyzes a call information event notified from the main apparatus BT to determine the fact that, for instance, the extension terminal T15 and the extension terminal T16 have been brought into a conversion, and adds state information “t5-t6” in the connection information management table 131.

The session control unit 122 reads out the fact that the extension terminal T15 is associated with the data terminal PC5, and the extension terminal T16 is associated with the data terminal PC6 from the extension terminal-VC association table 132, based on the foregoing state information, and retrieves the session states between the data terminals PC5 and PC6 from the session information management table 133. For example, in the case of beginning of a conversation from now, the session between the data terminals PC5 and PC6 not having been started yet, the session control unit 122 controls the beginning of the session so that the data terminals PC5 and PC6 start the session. When the session is established, the session control unit 122 then updates the storage content in the session information management table 133.

When the session control unit 122 establishes the session, the band assignment control unit 123 determines the respective group names of the data terminals PC5 and PC6 based on the group table 134. The data terminals PC5 and PC6 belonging to the Group 2 herein, the band assignment control unit 123 decides the communication band value to be assigned depending on the communication band table 135. As the combination is between the Group 2 and the Group 2 (Group 2-Group 2), it assigns the band value of “1.5 Mbps”.

Next, operations of the visual communication system configured mentioned above will be set forth.

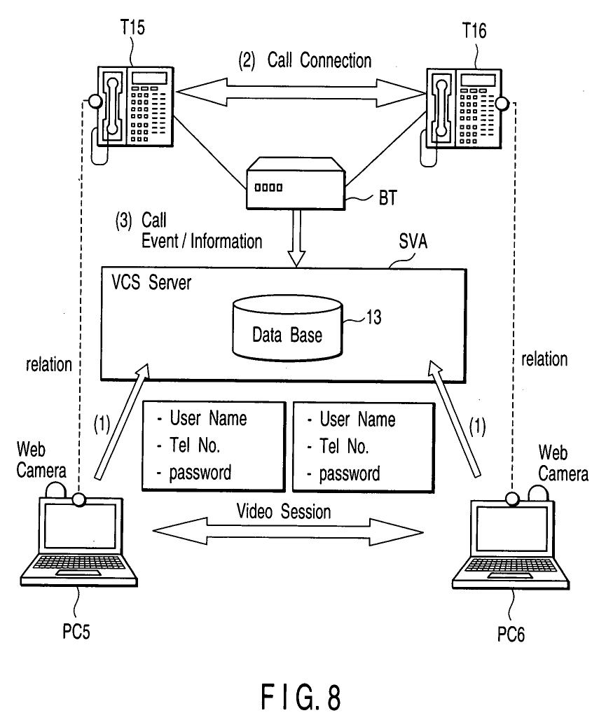

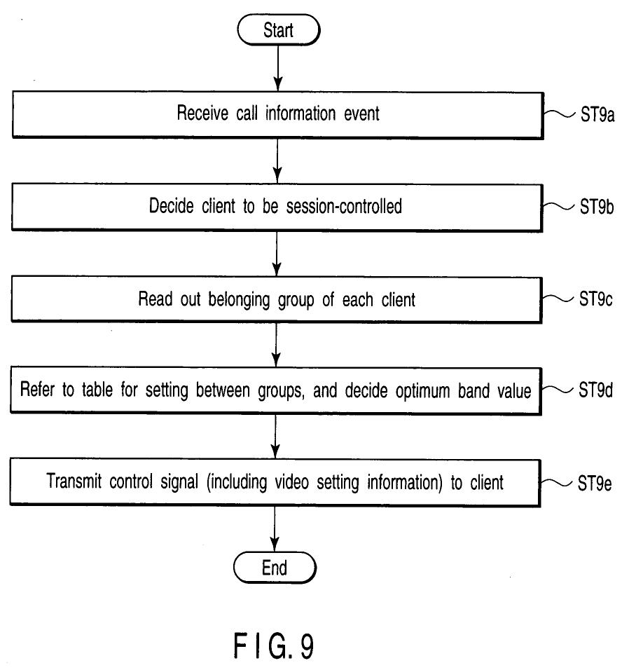

FIG. 8 is a sequence view illustrating operations in the case in which the data terminals PC5 and PC6 are associated with the extension terminals T15 and T16. FIG. 9 is a flowchart illustrating a control processing procedure of the VCS server SVA in deciding the communication band value to be assigned to the data terminals PC5 and PC6.

When logging onto the VCS server SVA, the data terminals PC5 and PC6 transmit user names (user IDs) and association telephone numbers to the VCS server SVA. Then, the VCS server SVA which has received them registers and stores them into the extension terminal-VC association table 132 of the storage unit 13, as client information (FIG. 8(1)).

For instance, it is presumed that, at the extension terminal T16, a user conducts an operation to request a conversation with the extension terminal T15. The extension terminal T16 then transmits the request signal to the main apparatus BT. When receiving the request signal of communication establishment, the main apparatus BT calls the extension terminal T15 at an incoming call destination. When the extension terminal T15 responds in response to the calling, the main apparatus BT forms a communication link between the extension terminal T15 and the extension terminal T16 (FIG. 8 (2)), and transmits a call information event indicating the fact that the extension terminals T15 and T16 are in their conversation to the VCS server SVA (FIG. 8 (3)).

When receiving the call information event (block ST9a), the VCS server SVA firstly makes association between the telephone IDs t5 and t6 of the extension terminals T15 and T16 to store the association in the connection information management table 131.

The VCS server SVA then refers to the extension terminal-VC association table 132 determines whether or not the data terminals PC5 and PC6 associated with the extension terminals T15 and T16, respectively, are present (block ST9b). Here, they being present, the VCS server SVA reads out the group “Group 2” with the data terminals PC5 and PC6 belonged thereto from the group table 134 (block ST9c), and decides an optimum band value “1.5 MHz” corresponding to “Group 2-Group 2” by referring to the communication band table 135 (block ST9d). The VCS server SVA transmits control signals to the data terminals PC5 and PC6 using the decided band value (block ST9e). After this, the data terminals PC5 and PC6 start video communication by using the received band value.

It is thought that the data terminals PC1 to PCn are placed in various network environments and they may utilize network bands differing in size. There is a possibility to make video communications in every environment, so that it is needed for band values used for communications to use appropriate values corresponding to the environments.

Therefore, grouping is performed by taking the network environments into consideration, then, optimum user bands may be set between each group. For example, it is supposed that the Group 1 uses a low usable band, and the Group 2 and the Group 3 present environments with certain degree of margins. A maintenance person may set to which group each data terminal PC1 to PCn should be belonged by a maintenance terminal for each data terminal PC1 to PCn, and the VCS server SVA stores the information of the setting. The maintenance person also sets the user band values among each group, when the conversation is started; the VCS server SVA grasps that to which group each data terminal PC1 to PCn belongs to decide optimum band values. In accordance with the communication band table 135, the low bands are used between the Group 1 and Group 2, and Group 1-Group 3, a band value with a certain level of height is used between the Group 2 and Group 3.

As mentioned above, in the first embodiment, the VCS server SVA is provided with the group table 134 in which a plurality of data terminals PC1 to PCn are grouped in response to the network environment to associate the groups (Group 1, Group 2 and Group 3) with a plurality of data terminals PC1 to PCn, and provided with the communication band table 135 in which the combinations of each group are associated with the band values usable among the plurality of data terminals PC1 to PCn to establish the session. When receiving the call information event from the main apparatus BT, the VCS server SVA refers to the group table 134 and the communication band table 135 to assign the communication bands by group to the data terminals PC5 and PC6 to establish the session.

Accordingly, for instance, when a plurality of companies, a plurality of departments, or individual persons are shared one system, the VCS server SVA may assign usable communication bands for each company, department, or individual person, thereby, the user who uses the system can make video communication in optimum states without having to be conscious of the environment of the user's itself.

The capacity of the storage unit 13 is not suppressed in comparison to the case that the communication bands are assigned for each data terminal PC1 to PCn, and further, the processing load may be reduced at the control unit 12.

### Second Embodiment

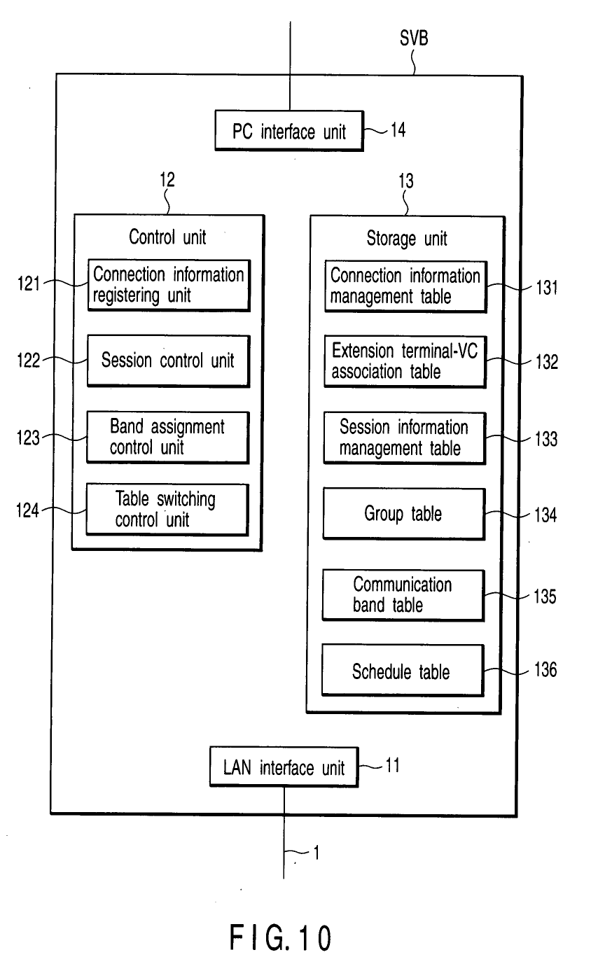

FIG. 10 is a block diagram illustrating a functional configuration of a VCS server SVB as a second embodiment of the present invention. In FIG. 10, the same identical components as those of FIG. 2 are designated by the identical symbols and the detailed description will be omitted.

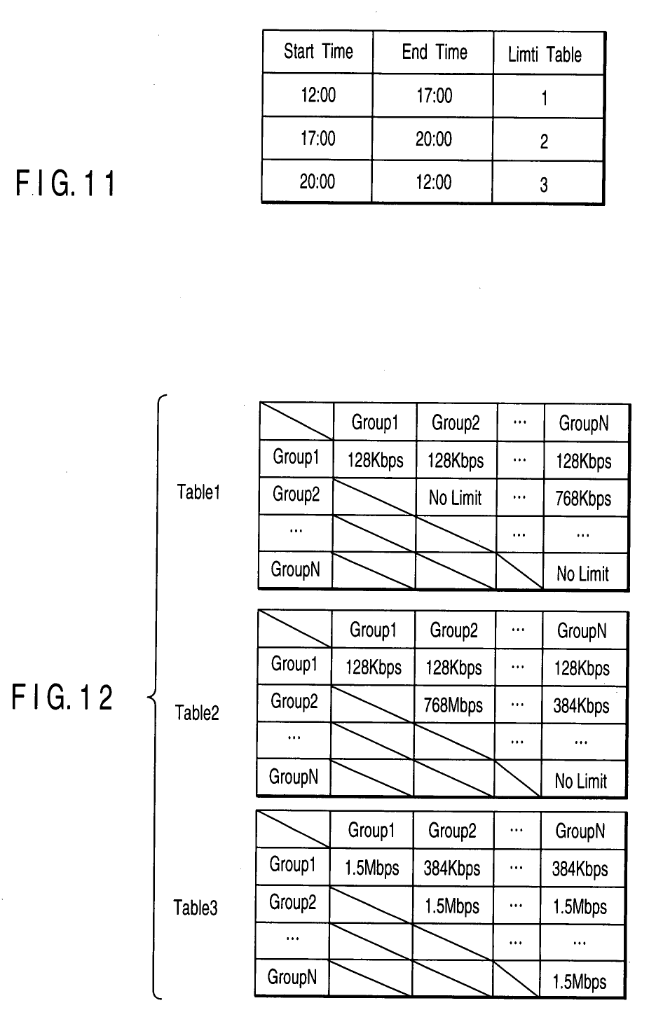

The storage unit 13 is provided with a schedule table 136. As shown in FIG. 11, the data, indicating the correspondence relation between time zone (start time and termination time) and identifiers of a plurality of communication band table 135, is stored in the schedule table 136.

Meanwhile, the control unit 12 has a table switching control unit 124. The table switching control unit 124 refers to the schedule table 136 to selectively set one of the plurality of communication band tables shown in FIG. 12 to an effective state.

Next to this, operations in the aforementioned configuration will be described.

In operations of the communication system, changing the setting for each time zone decided in a day enables setting further flexibly. In this case, if scheduling makes it possible to automatically change the setting, the burden of the maintenance person may be reduced.

Therefore, automatic setting by the scheduling is achieved by providing the aforementioned plurality of communication band tables 135 and by pre-registering the identifiers of the necessary communication band tables 135 by the maintenance person in response to the time zones.

In other words, for instance, when it is 17:00 o'clock, the VCS server SVB switches the communication band table 135 from the table 1 to the table 2. When it is 20:00 o'clock, it switches the band table 135 from the table 2 to the table 3, and when it is 12:00 o'clock, it switches the band table 135 from the table 3 to the table 1.

As mentioned above, according to the second embodiment, it becomes possible to automatically switch the communication band table 135 in response to, for instance, time zone, and the burden of the maintenance person who makes the setting is suppressed at minimum. As to the switching conditions for the communication band table 135, using, for example, communication traffic is a possible approach other than the use of time zone.

### Third Embodiment

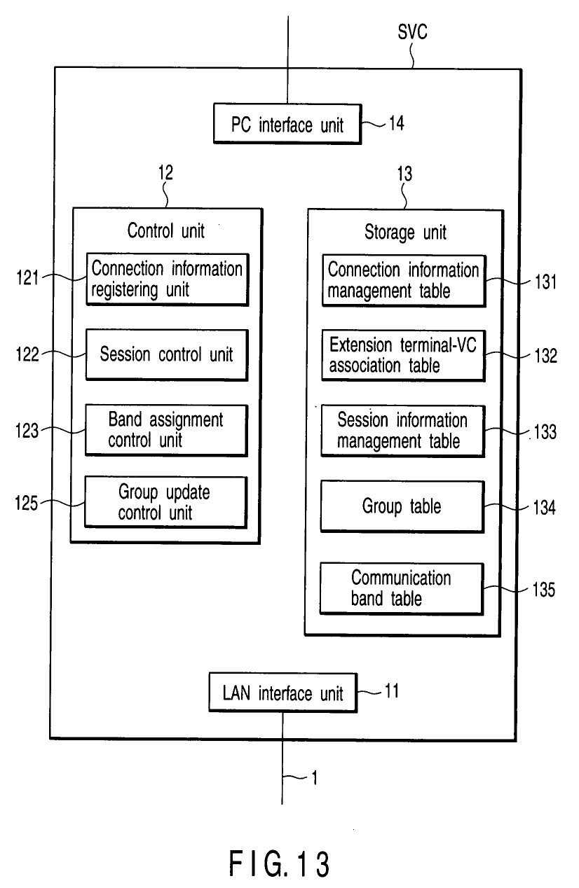

FIG. 13 is a block diagram illustrating a functional configuration of the VCS server SVC as a third embodiment of the present invention. In FIG. 13, the same components as those of FIG. 2 are designated by the identical symbols, and the detailed description will be omitted.

The control unit 12 has a group update control unit 125. The group update control unit 125 updates a group with the data terminal PC2 belonged thereto in the group table 134, for instance, when the data terminal PC2 is shifted from an office to a home.

The following will be described about operations in the configuration given above.

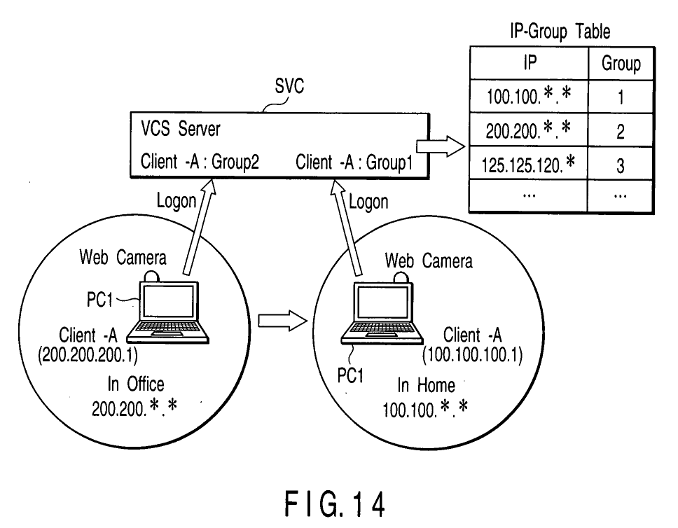

As shown in FIG. 14, it is thought that the user uses the system logs on from the data terminal PC1 placed in the office, and that the user uses it logs on from the data terminal PC1 placed in its own home as the case may be. That is, it is supposed that the identical client changes its use environment. The difference in environment frequently appears as a difference in IP address system. When the user logs on, as the VCS server SVC coming to know the IP address of the data terminal PC1 which logged on, the VCS server SVC becomes possible to switch the group for the data terminal PC1 in response to the environment by setting in advance the association between the IP address system and the groups by the maintenance person. Thereby, the communication system may correspond to the change in the use environment caused by the identical client.

It may be acceptable to switch the groups for the data terminals PC1 to PCn by using, for example, communication traffic, or time zone, other than the use place.

### Other Embodiment

The present invention is not limited to each of the embodiments given above. For instance, in each embodiment, the example to dispose a main apparatus and a VCS server separately having described; it may be possible to build in the function of the main apparatus into the VCS server.

Other than this, also as for the configuration and the type of the VCS server, the type of the telephone exchange (not limited to main apparatus but PBX is acceptable), the type of the extension terminal, the types of the data terminal, the storage contents of various tables, the session control method among data terminals, the group switching method, and the like, this invention may be embodied in various forms without departing from the sprit or scope of the inventive concept thereof.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as world fall within the scope and spirit of the inventions.

What is claimed is:

1. A server apparatus which receives a call information event including phone IDs specifying a plurality of phone terminals to be call-connected, and makes communication connections of a plurality of data terminals work together with the call connections, the data terminals being associated with the phone IDs of the plurality of phone terminals, respectively, and the data terminals being assigned data IDs, the server apparatus comprising:
a first memory which memorizes group tables respectively showing correspondence relations between groups constituted by dividing the plurality of data terminals and data IDs of data terminals belonging to these groups;
a second memory which memorizes band tables respectively showing correspondence relations between combinations of the plurality of groups and bands usable among plurality of data terminals to be communication-connected; and
a controller which refers to the group tables and the band tables based on data IDs associated with the phone IDs included in the call information event, when the call information event is received, and executes communication connections among data terminals corresponding to the data IDs based on the reference result to assign bands to the data terminals.

2. The server apparatus according to claim 1, further comprising an interface which connects a telephone exchange apparatus to execute exchange processing among plurality of phone terminals, wherein
the controller refers to the group tables and the band tables based on the call information event notified from the telephone exchange apparatus, and executes communication connections among data terminals based on the reference result to assign bands to these data terminals.

3. The server apparatus according to claim 1, further comprising a setting switching controller which selectively sets one of the plurality of band tables to an effective state based on prescribed conditions if the second memory memorizes a plurality of band tables differing from one another.

4. The server apparatus according to claim 3, wherein the setting switching controller uses any one of a time zone and communication traffic in order to determine the conditions.

5. The server apparatus according to claim 1, further comprising an updating unit which updates a group which belongs to the group table contains an arbitrary data terminal based on the prescribed conditions.

6. The server apparatus according to claim 5, wherein the updating unit uses a use place of an arbitrary data terminal to determine the conditions.
